(19) United States
(12) Patent Application Publication
(10) Pub. No.: US 2025/0252867 A1
(43) Pub. Date: Aug. 7, 2025

(54) IMMERSIVE AND CONTEXT-AWARE AUGMENTATIVE AND ALTERNATIVE COMMUNICATION

(71) Applicant: AAC Plus, Inc., Manvel, TX (US)

(72) Inventors: Dennis Francis Xavier, Lathrop, CA (US); Sanjay Ramchandra Shenoy, Manvel, TX (US)

(21) Appl. No.: 19/005,996

(22) Filed: Dec. 30, 2024

Related U.S. Application Data
(60) Provisional application No. 63/623,235, filed on Jan. 20, 2024.

(51) Int. Cl. G09B 21/00; G06F 3/0482; G06F 3/0484

(52) U.S. Cl. CPC G09B 21/00; G06F 3/0482; G06F 3/0484

(57) ABSTRACT

A device includes a processor, a display, an input component, and a memory. The memory includes instructions that cause the device to display a primary scene comprising a selectable model, display a secondary scene representative of the selectable model and comprising a selectable item, display an expression linguistically associated with the selectable item, and output a sentence including linguistic representations of the expression and the selectable item.

### BACKGROUND

Many people cannot rely on natural speech alone and need technology to help them communicate. This can include persons that have developmental disabilities and genetic conditions (e.g., autism, Down syndrome, cerebral palsy), persons that acquire disorders (e.g., traumatic brain injury, stroke, dysarthria), persons with progressive disorders (e.g., Parkinson's disease, motor neuron disease, amyotrophic lateral sclerosis), persons with cognitive-communication disorders (e.g., dementia, aphasia), and the like.

Augmentative and Alternative Communication (AAC) technology uses communication devices, systems, strategies and tools that replace or support natural speech by providing an alternative form of communication. Augmentative communication provides additional cues, context, or other information to a user's speech (e.g. sign language, pictures, symbols, a letter board) that clarifies the user's message to others. Alternative Communication provides communication for users who cannot speak or cannot be understood.

Conventional AAC technology uses a row-column grid of symbols. Each symbol occupies an individual cell within the grid, and the symbols may optionally be categorized or color coded to assist the user in locating the desired symbol. For example, a variety of symbols related to a given topic may be presented on a certain grid, such as a page of items related to people or food (categorically-related), a page of items related to a trip to the zoo (event-based), or a page of symbols supportive of building the structure of a sentence. A user's expression of a sentiment may require navigating through multiple grids successively to find and select the desired symbols. As each selection is made, a linguistic representation of the selection is generated. For example, to say “I want an apple”, the symbols for “I”, “want”, “an” and “apple” may be selected in sequence. Accordingly, grid displays are intended to support a range of speech by the user navigating through the grid structure.

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, where like reference numerals designate like structural elements, and in which:

FIG. 1A illustrates an example immersive and context-aware augmentative and alternative communication device;

FIG. 1B illustrates an example hallway environment shown on a display of the augmentative and alternative communication device;

FIG. 1C illustrates an example kitchen environment shown on a display of the augmentative and alternative communication device;

FIG. 1D illustrates an example kitchen environment with expressions shown on a display of the augmentative and alternative communication device;

FIG. 1E illustrates an example kitchen environment with a sentence shown on a display of the augmentative and alternative communication device;

FIG. 2 illustrates a flowchart of an example method for immersive and context-aware augmentative and alternative communication;

FIG. 3 illustrates a flowchart of another example method for immersive and context-aware augmentative and alternative communication;

FIG. 4 illustrates an example computer-readable medium including instructions for immersive and context-aware augmentative and alternative communication;

FIG. 5 illustrates another example computer-readable medium including instructions for immersive and context-aware augmentative and alternative communication.

### DETAILED DESCRIPTION

While conventional AAC technology is a life-changing technology that unlocks communication for those who struggle to or cannot otherwise communicate, there is a steep learning curve to the technology. Mastering grid-based systems requires significant training and practice, and can sometimes be very frustrating to users who want to quickly express a thought. Some common grid structures have 64 more symbols, and finding the desired symbols in the grid can be difficult. As a result, it is not uncommon for users to lose the motivation to use AAC technology, hampering their communication and social development. This is particularly true for children, who may not be able or motivated to navigate the grid-based systems.

In an example implementation consistent with the technologies disclosed herein, a display device (such as a tablet or phone) includes an interactive environment that depicts visualizations of components, models, and other items that represent aspects of the user's real-world context that can be selected in order to construct communications. The interactive environment is structured in a set of scenes, each providing a visualization of a model or sub-model associated with a real-world object, locale, or other aspect of the user's real-world context. For example, the interactive environment may include a scene depicting a visualization of the user's home. The user's home scene may include components representing the home's kitchen, living room, bathroom, and bedroom. Each of those components may be selectable. Upon the user selecting the kitchen, a new scene depicting a visualization of the user's kitchen is displayed, containing selectable components representing kitchen objects such as food, appliances, dishes, etc. The kitchen scene and other scenes may also include non-selectable components to provide a more realistic and immersive experience for the user.

Upon selecting an apple within the kitchen scene, a grouping of selectable expressions are displayed around the apple, each describing an associated emotion, action, or other expression related with the apple, such as “eat”, “want”, “don't like”, “more”, etc. When the user selects “want”, linguistic representations of the expression “want” and the item “apple” are displayed in a sentence builder. Additional linguistic representations may be added the sentence builder in order to form a complete communication. For example, when the user selects “want”, the sentence builder may display “I want an apple.” The sentence builder may provide multiple options to the user for a complete communication, such as “I want an apple” and “I want applesauce” and “I want apple juice.”

Once the communication in the sentence builder reflects the user's complete communication, the user can indicate that the sentence is completed, such as by selecting a “sentence complete” button. Then, the sentence is output by the device. For example, the sentence may be read out by a text to speech converter.

In this example, the AAC technology includes a gamified environment where the user has an avatar that can be customized as they desire, and where selecting items and expressions and completing sentences earns the user points as a game reward that can be used to unlock additional scenes, additional avatar customizations and other desirable features.

As can be appreciated by a person having ordinary skill in the art, the technology described herein provides a technical improvement to the operation of AAC technology by, for example, improving the display format of user-selectable interface elements, improving the efficiency of human operation of the technology, and providing a more desirable interface and interaction that motivates users to communicate through the technology more consistently, among other benefits.

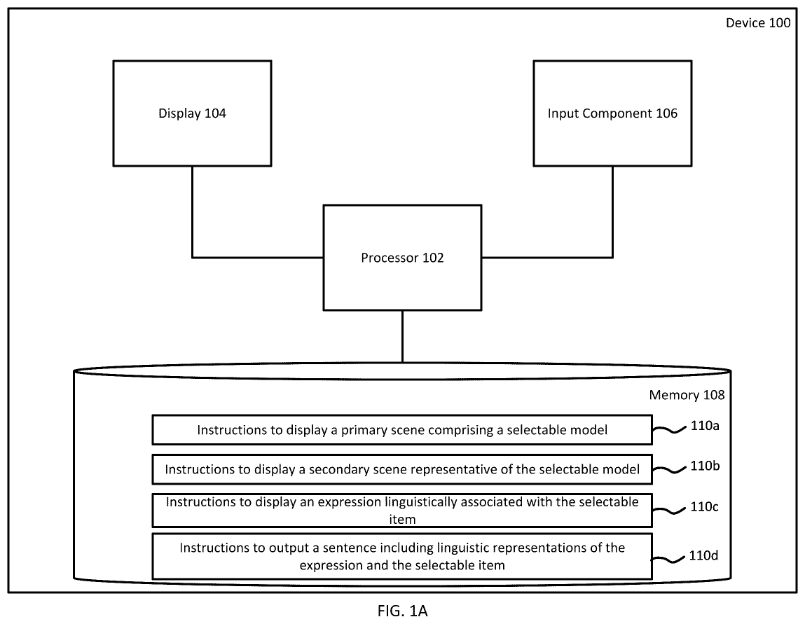

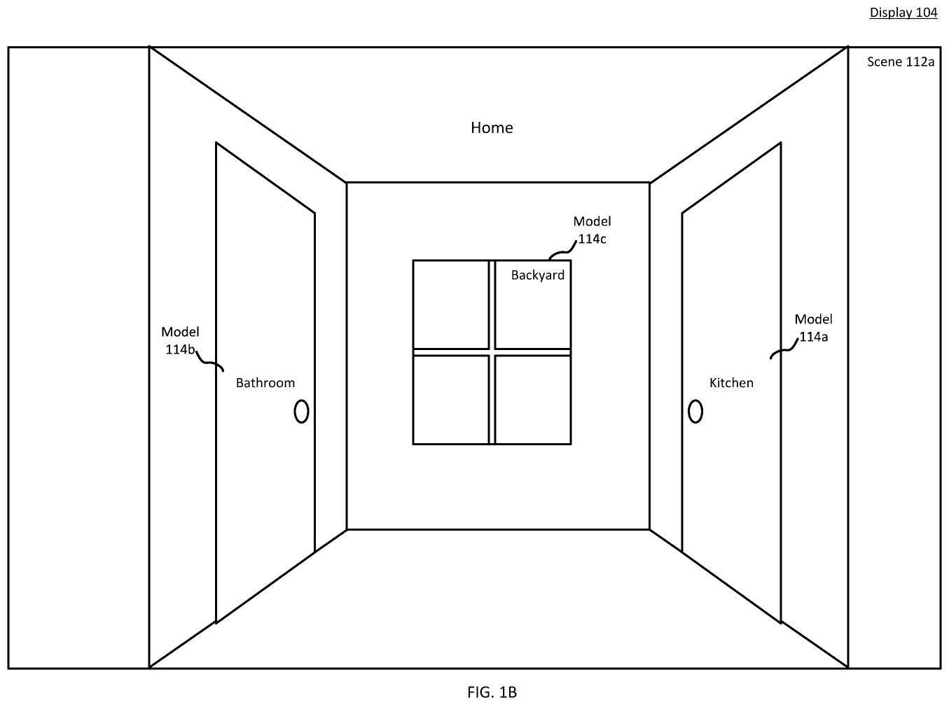

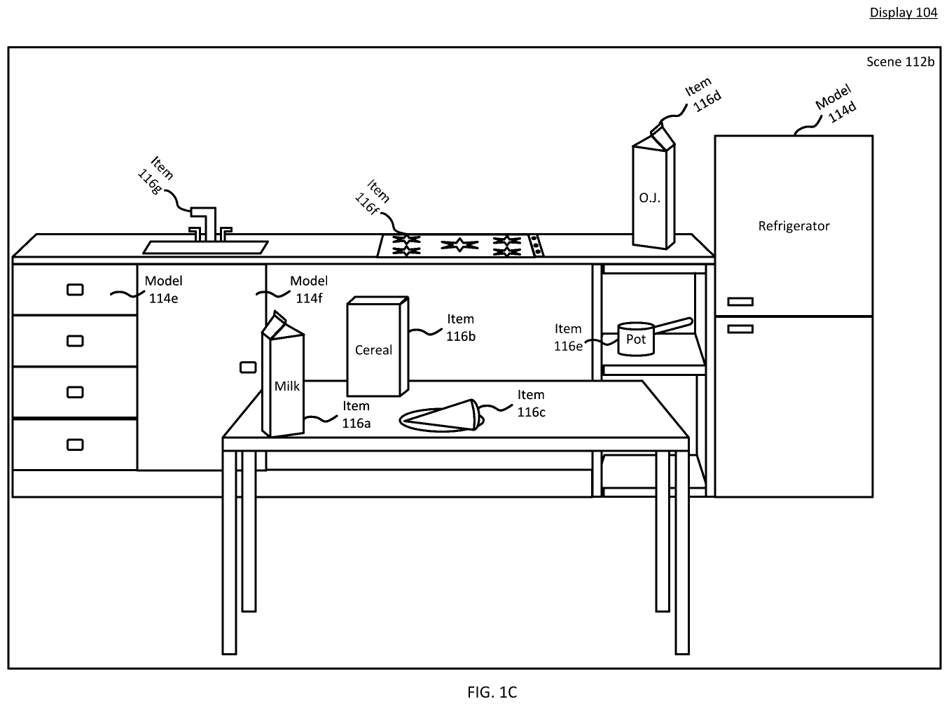

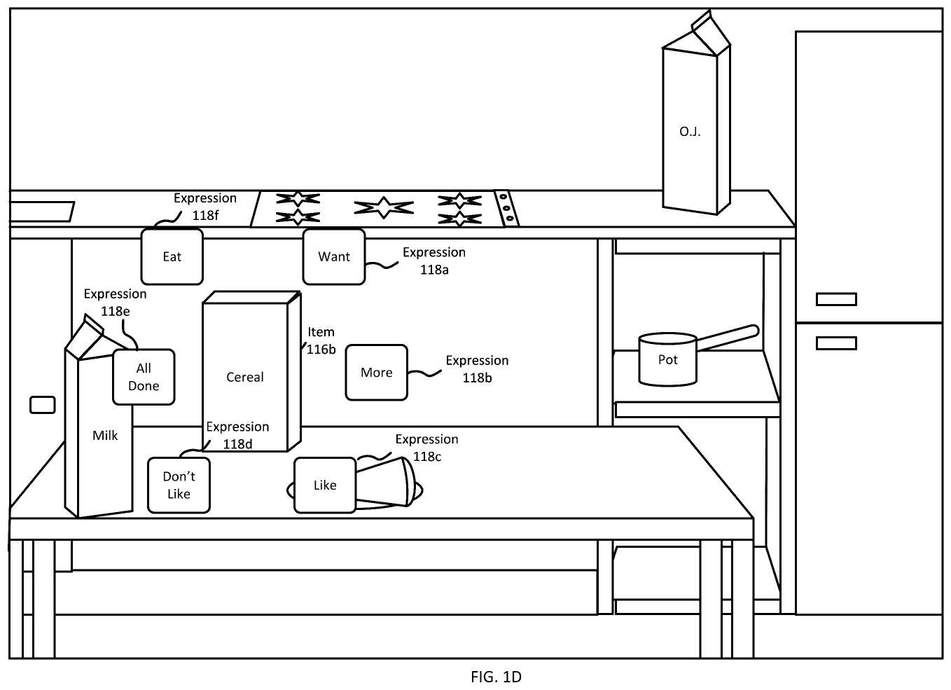

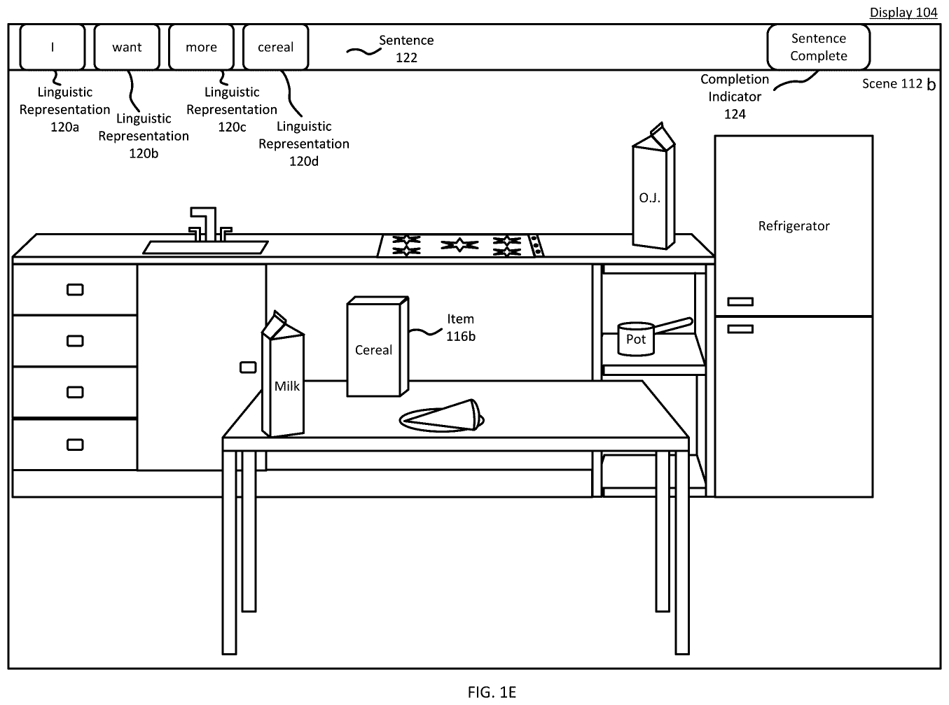

FIGS. 1 illustrate an example immersive and context-aware augmentative and alternative communication device. FIG. 1A illustrates an example device 100 including a processor 102, a display 104, input component 106, and memory 108. Device 100 is a device capable of receiving inputs from a user via input component 106 and displaying information to the user via display 104. Device 100 may be a tablet, phone, smart wearable (e.g. watch), virtual reality headset, heads-up display, smart glasses, or other computing device. Processor 102 may be one or more processing components such as a central processing unit (CPU), graphics processing unit (GPU), application specific integrated circuit (ASIC), system on a chip (SoC) or other processing component capable of executing instructions. Display 104 may be an integrated screen, a projected display, a separate display, or any other method of displaying information to the user. Input component 106 may be an integrated touchscreen (e.g. integrated with display 104, integrated in device 100), a keyboard, a joystick, a gesture input system, a gaming controller, one or more buttons or controllers on a wheel chair, mouse, trackpad, etc. In some embodiments, the device 100 may also be equipped with (or configured to communicate with) sensors for tracking the users eye movements, muscle movements or other gestures that may be used as input to navigate the scene, or any other method of capturing user inputs. Memory 108 may be a storage disk, hard drive, solid state drive, persistent memory, random access memory (RAM), processor cache, or any other form of non-transitory computer readable medium.

Memory 108 includes instructions 110. Instructions 110 cause device 100 to perform certain actions when executed by processor 102. Instructions 110 may be stored on device 100 in a traditional on-premises software deployment model, hosted on a third-party device and accessed via a webpage, provided as software as a service (Saas), or in any other locally or cloud deployed software model. In some examples, device 100 is a general-purpose device on which a software application is installed. In some other examples, device 100 is an integrated device provided as a single-purpose AAC technology unit.

Instructions 110a cause device 100 to display a primary scene comprising a selectable model. A scene is a graphical representation of an aspect of a user's real-life environment in an animated or otherwise illustrated format. The graphical representation may be displayed in any style or representation, including in two or three dimensions. The user may be able to configure the style or any other representational attributes of the scenes, as well as the configuration of elements in a given scene. The user may be able to upload information about real-life objects to more accurately relate the graphical representations in a scene to the real-life environment. For example, a user may be able to upload a photograph of a shirt and include a graphical representation of that shirt in a scene of the user's closet within the user's bedroom. The user may then be able to express “I want to wear my red Nike shirt” in relation to their real-world shirt. In another example, a user may be able to configure a scene of the user's kitchen to more accurately match the configuration of the user's real-life kitchen. A scene may comprise a graphical overlay over a camera image of or a real-life view of the user's real-life environment, such as augmented reality. The user is the operator of device 100. The user may be a person with limited or no verbal capabilities, a person who is unable to speak the predominant language of the region they are in, or an assistant of such a person. The primary scene represents a holistic or default view of the user's real-world environment. For example, the primary scene may be a “neighborhood” view showing various establishments the user frequents, such as the user's home, a deli, a supermarket, a place of worship, a playground, a school, etc. Alternatively, the primary scene may be a most commonly used establishment or scene such as the user's home, or the user's bedroom. The selection of which scene is the primary scene may be user configurable. A selectable model is a digital representation of an object in the user's real-life environment. A selectable model may be displayed in certain scenes via a graphical representation of that model. For example, in a neighborhood view, the user's home may be a selectable model, and the user's home may be represented graphically in the neighborhood view scene as an illustrated house. In the neighborhood view scene, the user may use input component 106 to select the illustrated house. In some examples, the models and scenes presented may vary based on time of day, season, weather, location, or other environmental and contextual aspects. For example, models for a restaurants that serve breakfast may be easily accessed from the neighborhood view scene (e.g. displayed as a walkable “Breakfast Avenue”) during the morning but is hidden or less accessible during the evening. In another example, an outdoor park is easily accessed during warm sunny weather but not during cold rainy weather. In yet another example, a Christmas themed version of the user's home scene is displayed during the month of December, and items, expressions, and models may be biased towards Christmas themes.

Instructions 110b cause device 100 to display a secondary scene representative of the selectable model, the secondary scene comprising a selectable item. Instructions 110b may be executed upon the user selecting a selectable model. For example, upon the user selecting an illustrated house representing a selectable model of the user's home, device 100 displays a secondary scene representative of the user's home. A secondary scene is a scene that is accessed by the user selecting a selectable model. A scene is representative of a selectable model due to it providing a graphical representation of aspects of the real-world object the selectable model represents. For example, a scene of a kitchen may include graphical representations of a refrigerator, a cabinet, a sink, a dining table, and objects that would be commonly found in a kitchen. Within a scene, there may be graphical representations of selectable models or sub-models, graphical representations of selectable items, and graphical representations of non-selectable objects, as is appropriate for a particular scene. Selectable models are different from selectable items in that the selectable models include representative scenes and selectable items do not. For example, a refrigerator may be a selectable model because, upon selection, device 100 displays a scene depicting an opened refrigerator with objects inside of it, but an apple is a selectable item because, upon selection, there is no different scene displayed. Sub-models are models accessible from scenes associated with models. For example, the refrigerator is a sub-model since it is accessible from the kitchen scene. In some examples, selectable models are capable of behaving as selectable items when the user selects them in a certain manner. For example, if the refrigerator is long pressed, device 100 displays a scene depicting an opened refrigerator, but if the refrigerator is short pressed, device 100 treats the refrigerator as a selectable item. In some examples, information presented in a scene may be provided by third parties. For example, in a secondary scene of a real-world coffee shop, the selectable items are representative items from the coffee shop's menu, and the user can access the coffee shop's current real-world menu within the secondary scene. In some examples, a third party's software may execute within a scene to allow the user to interface with the third party's software while navigating within the secondary scene. For example, in a secondary scene of a real-world coffee shop, there may be a representation of a tablet or a kiosk that, when selected, launches the coffee shop's software application. In some examples, the third party may operate virtual real estate within the AAC technology, providing additional customization to the models and scenes associated with their establishments. For example, the real-world coffee shop may create customized scenes that replicate aspects of the real-world coffee shop, and may include software integrations that allow direct ordering, viewing of a menu or other product listing of the current products for sale, or other interaction with the coffee shop from the AAC technology. In some examples, displaying the secondary scene may include providing an animation or other transition between the primary scene and the secondary scene. For example, if the secondary scene is represented as being behind a door displayed in the primary scene, the door may open and the camera perspective may shift to represent traversing the doorframe into the secondary scene. In another example, if the secondary scene is represented as a building, the camera perspective may shift to represent entering the building.

In some examples, selecting a model, an item, or an expression, or navigating between scenes or within a scene in certain ways may result in game points being awarded to the user. Game points may be used to customize the user's avatar, buy new scenes, buy decorative elements, enable desirable features, unlock games, or enable other functionalities. In some examples, a variety of inputs or a number of similar inputs may result in game point being awarded to the user. For example, a user may gain 100 points for interacting with the apple 50 times.

In some examples, selecting a model, an item, or an expression, or navigating between scenes or within a scene in certain ways may result in an animation or other transition being displayed. For example, if the user selects a refrigerator, the refrigerator door may open and the camera perspective may shift to view the interior of the refrigerator. In another example, if the user selects an apple, the apple may be centered within the scene and enlarged. As would be apparent to a person having ordinary skill in the art, all scenes, models, items, expression, and other display elements can be animated in response to triggers, including user selection, user hover, timeout, or any other event trigger.

Instructions 110c cause device 100 to display an expression linguistically associated with the selectable item. An expression is a word, phrase, thought, or emotion that is linguistically associated with an item. An expression is linguistically associated with an item when the expression conveys a sentiment about the item when paired with the item. For example, an expression of “want” can linguistically associated with the item “apple” to convey the sentiment “I want an apple”. Device 100 may display the expression upon the user selecting the selectable item. For example, when the user selects an apple, one or more expressions (e.g. “want”, “eat”, “don't like”, “all done”) may be displayed in proximity to the apple. The expressions may be a curated list of common expressions, a list of common expressions relating to the item, a user-selected list of expressions, or a dynamically generated list of likely expressions relating to the item based on frequency analysis, grammatical analysis, contextual analysis, or other deterministic or machine learning analysis. Such analysis may be conducted in relation to the specific item (e.g. frequency analysis relating to “apple” to determine most common expressions), in relation to a broader category (e.g. frequency analysis relating to fruit to determine most common expressions), in relation to a contextual factor (e.g. contextual analysis in relation to the time of day to determine the most likely expressions relating to “bed”), or other factors as is appropriate given the item.

In some examples, the displayed expression is a quick expression, and another element is displayed to the user that enables the user to display a broader listing of expressions related to the selected item. For example, a “grid” button is displayed along with the quick expression, and when the user selects the grid button, a grid of a larger number of expressions (e.g. 32 expressions, 64 expressions, etc.) is displayed. In some examples, the grid of expressions is a curated list of contextually appropriate expressions. For example, the grid of expressions when an apple is selected is a grid relating to fruits. In another example, the grid of expressions when a dining plate is selected around noontime is a grid relating to lunch. In yet another example, the grid of expressions when a milk carton is selected is a grid of the user's most frequently used kitchen expressions. In some examples, a portion of the grid displays quick expressions, including the displayed expression.

In certain examples, the grid button is displayed also when there is no item selected. Upon selecting the grid button, a grid may be displayed to the user that is contextually appropriate given the current scene being displayed, time of day, time of year, user's configuration, and other contextual aspects. Within the grid, the user may select a selectable item. For example, the user may select the “apple” element within the grid. Upon such a selection of an item, the expression linguistically associated with the selectable item may be displayed within a portion of the grid for displaying quick expressions. For example, upon selecting the apple element, a portion of the existing grid may be cropped, the grid may be resized, or grid elements may be replaced in order to display quick expressions linguistically associated with “apple”, such as “eat”, “don't like”, and “more”.

Instructions 110d cause device 100 to output a sentence including linguistic representations of the expression and the selectable item. A sentence is a partial or complete sentiment. A sentence may be a literal complete sentence, a portion of a complete sentence, multiple sentences, or any other combination of words and phrases that communicate portions of or all of a sentiment. A sentiment is a thought, emotion or other communication. A linguistic representation is a selectable word, phrase, or thought associated with a model, item, or expression. For example, the user may select a graphical representation (e.g. an animated image) of an apple. The linguistic representation associated with the apple may be the word “apple”. There may be more than one linguistic representation associated with a particular object. For example, the user's selection of an apple may be associated with “apple”, “apples”, “an apple”, “three apples”, “fruit”, “snack”, “the apple”, “applesauce”, or “apple juice”, depending on grammatical and other context. In some examples, a most likely linguistic representation is included in the sentence. In certain examples, the user may provide input via input component 106 to change the linguistic representation to a different linguistic representation of the object, reorder the linguistic representation within the sentence, or remove the linguistic representation from the sentence. Outputting the sentence may comprise outputting audio of the sentence in the language of the linguistic representation (i.e. if the linguistic representation is in English, the audio is in English) from a speaker or other audio device. Alternatively, outputting the sentence may comprise outputting audio of the sentence in a different language, displaying the sentence in the language of the linguistic representation, displaying the sentence in a different language, or otherwise communicating the sentence to a recipient of the communication. In some examples, outputting the sentence transmits the sentence to a smart device to be audibly output by the smart device or to be used as instructions by the smart device. For example, outputting the sentence “turn off the living room lamp” may be output to a smarthome hub that then turns off the living room lamp. In some examples, different sentences are output in different ways depending on the purpose of the sentence. For example, “I want an apple” may be audibly output and “Turn off the living room lamp” may be transmitted as an instruction to a smarthome hub.

FIG. 1B illustrates a display 104 displaying a primary scene 112a. Primary scene 112a includes model 114a, model 114b, and model 114c. Primary scene 112a represents an entryway to the user's home. Model 114a is a graphical representation of the user's kitchen. For example, model 114a is a door labeled “Kitchen.” Model 114b is a graphical representation of the user's bathroom. For example, model 114b is a door labeled “Bathroom.” Model 114c is a graphical representation of the user's backyard. For example, model 114c is a window labeled “Backyard.” Models 114 are selectable models. The user can use input component 106 to select a model 114. Upon selection of a model 114, device 100 may display a secondary scene. In some examples, the user can navigate from a scene to other scenes via inputs other than selecting a model 114. For example, a user may move a joystick to the right to navigate from primary scene 112a to a scene representing model 114a. In some examples, the user can navigate within a scene via inputs. For example, a user may move a joystick to the right to turn within primary scene 112a to view another portion of the home's primary scene 112a.

FIG. 1C illustrates a display 104 displaying a secondary scene 112b. Primary scene 112b includes model 114d-114f, and items 116a-116g. Model 114d is a graphical representation of the user's refrigerator. Model 114e is a graphical representation of a drawer in the user's kitchen. Model 114f is a graphical representation of a cabinet in the user's kitchen. Item 116a is a graphical representation of a milk carton. Item 116b is a graphical representation of a cereal box. Item 116c is a graphical representation of a pizza. Item 116d is a graphical representation of a carton of orange juice. Item 116e is a graphical representation of a pot. Item 116f is a graphical representation of a stove. Item 116g is a graphical representation of a sink. Each model 114 is a user selectable model and each item 116 is a user selectable item.

FIG. 1D illustrates a display 104 displaying a secondary scene 112b with an overlay of expressions 118. In some examples, the overlay of expressions 118 is displayed upon the user selecting item 116b. Expression 118a is an expression of “want”. Expression 118b is an expression of “more”. Expression 118c is an expression of “like”. Expression 118d is an expression of “don't like”. Expression 118e is an expression of “all done”. Expression 118f is an expression of “eat”. In some examples, expressions 118 include a graphical representation of the expression, such as a sign language representation, an illustration, an icon, or another representation. In certain examples, expressions 118 include a linguistical representation of the expression, such as a word, phrase, concept, or thought.

FIG. 1E illustrates a display 104 displaying a secondary scene 112b with a sentence 122. Sentence 122 includes linguistic representations 120, and completion indicator 124. Linguistic representation 120a represents the word “I”. Linguistic representation 120b represents the word “want”. Linguistic representation 120c represents the word “more”. Linguistic representation 120d represents the word “cereal”. Therefore, sentence 122 represents the thought “I want more cereal.” In some examples, linguistic representations 120 can be reordered by the user. In certain examples, linguistic representations 120 can be selected by the user to provide user with alternative linguistic representations 120. For example, if user selects linguistic representation 120c, user may be presented with options to change linguistic representation 120c from “more” to “less”, “three”, “all”, etc. or to remove linguistic representation 120c from sentence 122. In certain examples, linguistic representations 120a and 120b are not linguistic representations of expressions or items selected by the user, but are inserted to create a grammatically complete sentence 122. In some examples, the inserted linguistic representations are presented to the user as an optional sentence completion prior to insertion into the sentence. In some other examples, the inserted linguistic representations are automatically inserted into the sentence 122. In certain examples, additional linguistic representations that are likely next selectable words are suggested to the user. For example, the likely next selectable word “tomorrow” could be suggested for the sentence “I want more cereal” to make the new sentence “I want more cereal tomorrow”. In certain examples, linguistic representations 120d of selected items are considered “fringe words” and linguistic representations 120c of expressions are considered “core words”. In certain examples, fringe words and core words may be stylized, color coded, organized or otherwise identified in consistent ways to provide users with a consistent experience when building sentences 122. For example, nouns may be blue and adverbs may be orange or nouns may be listed in a first column of a grid and adverbs in third column.

User indicates sentence completion by selecting completion indicator 124. In some examples, completion indicator 124 is a selectable button or other graphical widget that user can select. In some other examples, completion indicator 124 may be a gesture or a physical button or any other input user can make to indicate sentence completion.

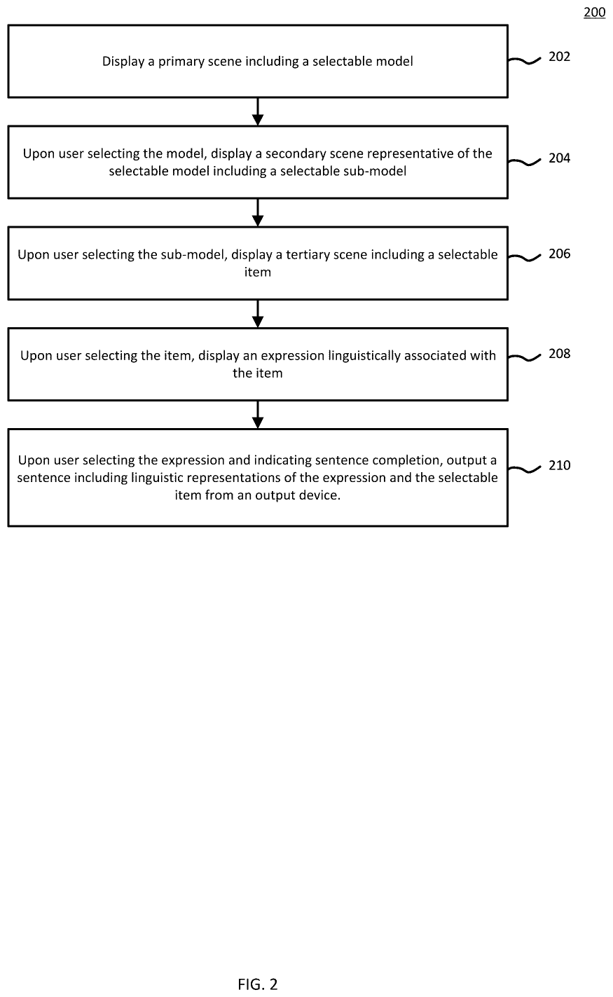

FIG. 2 illustrates a flowchart of an example method 200 for immersive and context-aware augmentative and alternative communication. Method 200 includes blocks 202-210.

Block 202 causes a device to display a primary scene including a selectable model. In some examples, the device may also display an avatar of the user within the primary scene, allowing the user to navigate the primary scene via the avatar.

Block 204 causes the device to display a secondary scene representative of the selectable model, the secondary scene including a selectable sub-model. Block 204 may occur upon the user selecting a selectable model. For example, upon the user selecting an illustrated house representing a selectable model of the user's home, the device displays a secondary scene representative of the user's home.

Block 206 causes the device to display a tertiary scene representative of the selectable sub-model, the tertiary scene including a selectable item. Block 206 may occur upon the user selecting a selectable sub-model. For example, upon the user selecting an illustrated kitchen door representing a selectable sub-model of the user's kitchen, the device displays a tertiary scene representative of the user's kitchen including an apple.

Block 208 causes the device to display an expression linguistically associated with the selectable item. Block 208 may occur upon the user selecting a selectable item. For example, upon the user selecting an apple, the device displays an expression linguistically associated with the apple.

Block 210 causes the device to output a sentence including linguistic representations of the expression and the selectable item. Block 210 may occur upon the user selecting the expression and indicating sentence completion. The device may output the sentence from an output device such as an audio device or other appropriate device.

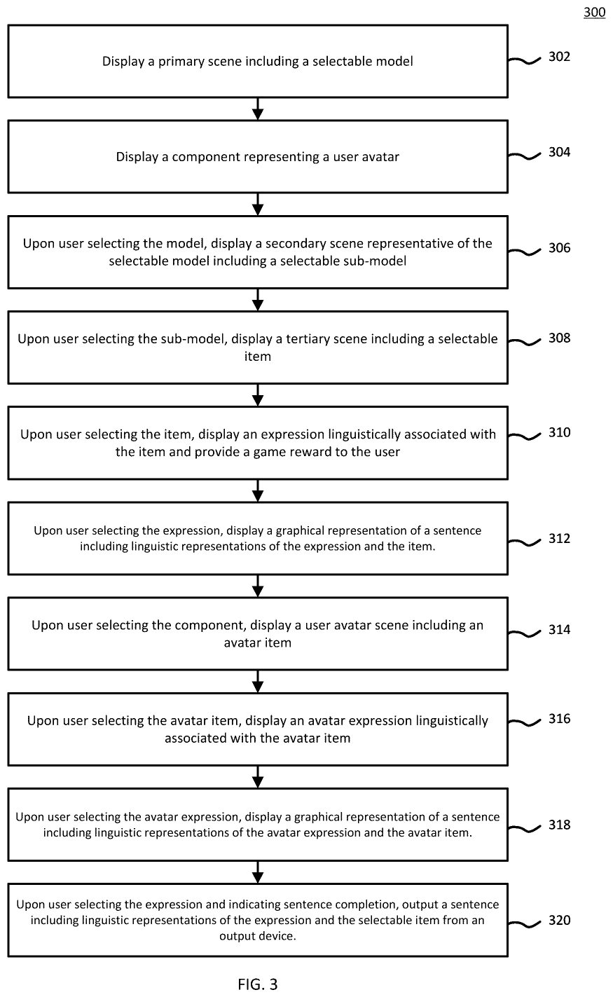

FIG. 3 illustrates a flowchart of another example method 300 for immersive and context-aware augmentative and alternative communication. Method 300 includes blocks 302-320.

Block 302 causes a device to display a primary scene including a selectable model. In some examples, the device may also display an avatar of the user within the primary scene, allowing the user to navigate the primary scene via the avatar.

Block 304 causes a device to display a selectable avatar component representing a user avatar. In some examples, the device may display a customized graphical representation of the avatar.

Block 306 causes the device to display a secondary scene representative of the selectable model, the secondary scene including a selectable sub-model. Block 306 may occur upon the user selecting a selectable model. For example, upon the user selecting an illustrated house representing a selectable model of the user's home, the device displays a secondary scene representative of the user's home.

Block 308 causes the device to display a tertiary scene representative of the selectable sub-model, the tertiary scene including a selectable item. Block 308 may occur upon the user selecting a selectable sub-model. For example, upon the user selecting an illustrated kitchen door representing a selectable sub-model of the user's kitchen, the device displays a tertiary scene representative of the user's kitchen including an apple.

Block 310 causes the device to display an expression linguistically associated with the selectable item. Block 310 may occur upon the user selecting a selectable item. For example, upon the user selecting an apple, the device displays an expression linguistically associated with the apple.

Block 312 causes the device to display a graphical representation of a sentence including linguistic representations of the expression and the item upon the user selecting the expression. In some examples, artificial intelligence or other computational processes may generate additional selectable words to include in the sentence to more fully express a grammatically complete sentiment.

Block 314 causes the device to display an avatar scene including an avatar item upon the user selecting the selectable avatar component. In some examples, the avatar scene may include a graphical representation of the user (i.e. avatar) generated from an uploaded photo of the user. In certain examples, the avatar may include clothing, hairstyles, accessories, avatar characteristics and other aspects and objects that are user customizable and/or purchasable using game reward points.

Block 316 causes the device to display an avatar expression linguistically associated with the avatar item. Avatar expressions may relate to the user's feelings or actions associated with the avatar item. For example, if the user selects the stomach avatar item, avatar expressions may represent “I am hungry” and “My stomach hurts”, whereas if the user selects the head avatar item, avatar expressions may represent emotions, such as “I am happy” or “I am sad”.

Block 318 causes the device to display a graphical representation of a sentence including linguistic representations of the expression, the avatar expression, the item and the avatar item upon the user selecting the avatar expression. For example, selecting “eat”, “apple”, “head”, “happy” may result in the sentence “Eating an apple makes me happy.” In some examples, artificial intelligence or other computational processes may generate additional selectable words to include in the sentence to more fully express a grammatically complete sentiment. As can be appreciated by the reader, there may be many paths to expressing similar sentiments, so any combination of items and expressions (including avatar items and expressions) may result in a sentence that expresses the user's desired sentiment.

Block 320 causes the device to output the sentence. Block 320 may occur upon the user selecting the expression and indicating sentence completion. The device may output the sentence from an output device such as an audio device or other appropriate device.

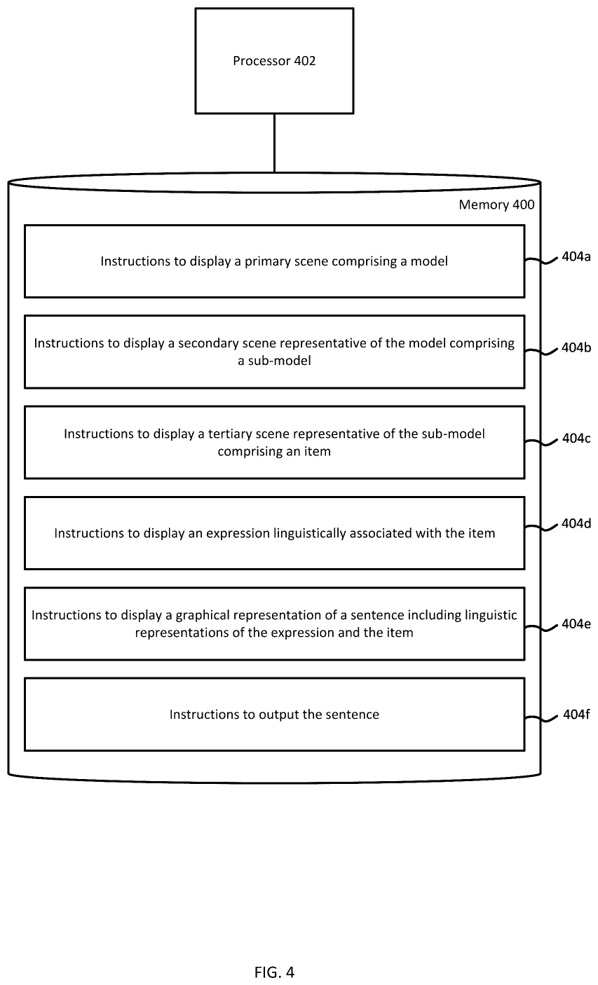

FIG. 4 illustrates an example computer-readable medium including instructions for immersive and context-aware augmentative and alternative communication. Memory 400 is communicatively coupled to processor 402. Instructions 404 cause a device to perform certain actions when executed on processor 402.

Instructions 404a cause a device to display a primary scene including a selectable model. In some examples, the device may also display an avatar of the user within the primary scene, allowing the user to navigate the primary scene via the avatar.

Instructions 404b cause the device to display a secondary scene representative of the selectable model, the secondary scene including a selectable sub-model, upon the user selecting a selectable model. For example, upon the user selecting an illustrated house representing a selectable model of the user's home, the device displays a secondary scene representative of the user's home.

Instructions 404c cause the device to display a tertiary scene representative of the selectable sub-model, the tertiary scene including a selectable item, upon the user selecting a selectable sub-model. For example, upon the user selecting an illustrated kitchen door representing a selectable sub-model of the user's kitchen, the device displays a tertiary scene representative of the user's kitchen including an apple.

Instructions 404d cause the device to display an expression linguistically associated with the selectable item upon the user selecting a selectable item. For example, upon the user selecting an apple, the device displays an expression linguistically associated with the apple.

Instructions 404e cause the device to display a graphical representation of a sentence including linguistic representations of the expression and the item upon the user selecting the expression. In some examples, artificial intelligence or other computational processes may generate additional selectable words to include in the sentence to more fully express a grammatically complete sentiment.

Instructions 404f cause the device to output a sentence including linguistic representations of the expression and the selectable item upon the user indicating sentence completion. The device may output the sentence from an output device such as an audio device or other appropriate device.

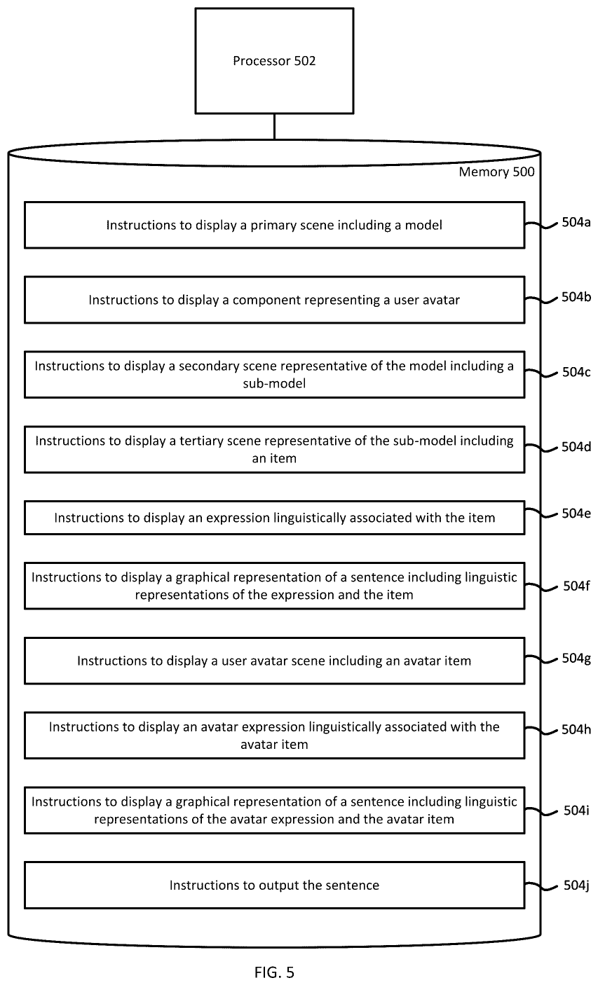

FIG. 5 illustrates another example computer-readable medium including instructions for immersive and context-aware augmentative and alternative communication. Memory 500 is communicatively coupled to processor 502. Instructions 504 cause a device to perform certain actions when executed on processor 502.

Instructions 504a cause a device to display a primary scene including a selectable model. In some examples, the device may also display an avatar of the user within the primary scene, allowing the user to navigate the primary scene via the avatar.

Instructions 504b cause a device to display a selectable avatar component representing a user avatar. In some examples, the device may display a customized graphical representation of the avatar.

Instructions 504c cause the device to display a secondary scene representative of the selectable model, the secondary scene including a selectable sub-model, upon the user selecting a selectable model. For example, upon the user selecting an illustrated house representing a selectable model of the user's home, the device displays a secondary scene representative of the user's home.

Instructions 504d cause the device to display a tertiary scene representative of the selectable sub-model, the tertiary scene including a selectable item, upon the user selecting a selectable sub-model. For example, upon the user selecting an illustrated kitchen door representing a selectable sub-model of the user's kitchen, the device displays a tertiary scene representative of the user's kitchen including an apple.

Instructions 504e cause the device to display an expression linguistically associated with the selectable item upon the user selecting a selectable item. For example, upon the user selecting an apple, the device displays an expression linguistically associated with the apple.

Instructions 504f cause the device to display a graphical representation of a sentence including linguistic representations of the expression and the item upon the user selecting the expression. In some examples, artificial intelligence or other computational processes may generate additional selectable words to include in the sentence to more fully express a grammatically complete sentiment.

Instructions 504g cause the device to display an avatar scene including an avatar item upon the user selecting the selectable avatar component. In some examples, the avatar scene may include a graphical representation of the user (i.e. avatar) generated from an uploaded photo of the user. In certain examples, the avatar may include clothing, hairstyles, accessories, avatar characteristics and other aspects and objects that are user customizable and/or purchasable using game reward points.

Instructions 504h cause the device to display an avatar expression linguistically associated with the avatar item. Avatar expressions may relate to the user's feelings or actions associated with the avatar item. For example, if the user selects the stomach avatar item, avatar expressions may represent “I am hungry” and “My stomach hurts”, whereas if the user selects the head avatar item, avatar expressions may represent emotions, such as “I am happy” or “I am sad”.

Instructions 504i cause the device to display a graphical representation of a sentence including linguistic representations of the expression, the avatar expression, the item and the avatar item upon the user selecting the avatar expression. For example, selecting “eat”, “apple”, “head”, “happy” may result in the sentence “Eating an apple makes me happy.” In some examples, artificial intelligence or other computational processes may generate additional selectable words to include in the sentence to more fully express a grammatically complete sentiment. As can be appreciated by the reader, there may be many paths to expressing similar sentiments, so any combination of items and expressions (including avatar items and expressions) may result in a sentence that expresses the user's desired sentiment.

Instructions 504j causes the device to output the sentence upon the user indicating sentence completion. The device may output the sentence from an output device such as an audio device or other appropriate device.

The features of the present disclosure can be implemented using a variety of specific devices that contain a variety of different technologies and characteristics. As an example, features that include instructions to be executed by processing circuitry may store the instructions in a cache of the processing circuitry, in random access memory (RAM), in hard drive, in a removable drive (e.g. CD-ROM), in a field programmable gate array (FPGA), in read only memory (ROM), or in any other non-transitory, computer-readable medium, as is appropriate to the specific device and the specific example implementation. As would be clear to a person having ordinary skill in the art, the features of the present disclosure are not altered by the technology, whether known or as yet unknown, and the characteristics of specific devices the features are implemented on. Any modifications or alterations that would be required to implement the features of the present disclosure on a specific device or in a specific example would be obvious to a person having ordinary skill in the relevant art.

Although the present disclosure has been described in detail, it should be understood that various changes, substitutions and alterations can be made without departing from the spirit and scope of the disclosure. Any use of the words “may” or “can” in respect to features of the disclosure indicates that certain examples include the feature and certain other examples do not include the feature, as is appropriate given the context. Any use of the words “or” and “and” in respect to features of the disclosure indicates that examples can contain any combination of the listed features, as is appropriate given the context.

Phrases and parentheticals beginning with “e.g.” or “i.e.” are used to provide examples merely for the purpose of clarity. It is not intended that the disclosure be limited by the examples provided in these phrases and parentheticals. The scope and understanding of this disclosure may include certain examples that are not disclosed in such phrases and parentheticals.

1. A device, comprising:
a processor;
a display;
an input component; and
a memory including instructions that, when executed by the processor, cause the device to:
display a primary scene comprising a selectable model and a selectable item;
upon a user selecting the selectable item of the primary scene, display an expression linguistically associated with the selectable item; and
upon the user indicating sentence completion, output a sentence including linguistic representations of the expression and the selectable item.

2. The device of claim 1, wherein the memory includes instructions that, when executed by the processor, cause the device to:
upon the user selecting the expression, display a graphical representation of a sentence including linguistic representations of the expression and the selectable item,
wherein the graphical representation of the sentence displays the linguistic representations of the expression and the selectable item in an ordered listing of selectable words that form a partial or complete sentiment, and
wherein each of the selectable words may be removed, reordered, or otherwise modified by the user.

3. The device of claim 1, wherein the memory includes instructions that, when executed by the processor, cause the device to:
upon the user selecting the selectable model of the primary scene, display a secondary scene representative of the selectable model, the secondary scene comprising a second selectable item; and
upon the user selecting the second selectable item of the secondary scene, display an expression linguistically associated with the secondary selectable item.

4. The device of claim 1, wherein the memory includes instructions that, when executed by the processor, cause the device to:
display a selectable component representing a user avatar;
upon the user selecting the selectable component, display a user avatar scene comprising a selectable avatar item;
upon the user selecting the selectable avatar item, display an avatar expression linguistically associated with the selectable avatar item; and
upon the user selecting the avatar expression, display a graphical representation of a sentence including linguistic representations of the avatar expression and the selectable avatar item.

5. The device of claim 1, wherein the sentence is output in a language other than the language in which the graphical representation is displayed.

6. The device of claim 1, wherein the primary scene is a representation of a real-world commercial establishment, and wherein the secondary scene includes a product listing including the current products for sale at the real-world commercial establishment.

7. The device of claim 1, wherein the selectable item is hidden at times when the user is not likely to select the item.

8. A method, comprising:
displaying, on a display device, a primary scene comprising a selectable model;
upon a user selecting the selectable model of the primary scene, displaying, on the display device, a secondary scene representative of the selectable model, the secondary scene comprising a selectable sub-model;
upon the user selecting the selectable sub-model, displaying, on the display device, a tertiary scene comprising a selectable item;
upon the user selecting the selectable item, displaying, on the display device, an expression linguistically associated with the selectable item;
upon the user indicating sentence completion, outputting, from an output device, a sentence including linguistic representations of the expression and the selectable item.

9. The method of claim 8, further comprising
upon the user selecting the expression, displaying a graphical representation of a sentence including linguistic representations of the expression and the selectable item,
wherein the graphical representation of the sentence displays the linguistic representations of the expression and the selectable item in an ordered listing of selectable words that form a partial or complete sentiment.

10. The method of claim 9, wherein each of the selectable words is removable, reorderable, and modifiable by the user.

11. The method of claim 9, wherein a likely next selectable word is suggested to the user.

12. The method of claim 9, wherein a sentence completion is suggested to the user.

13. The method of claim 8, further comprising:
displaying, on the display device, a selectable component representing a user avatar;
upon the user selecting the selectable component, displaying, on the display device, a user avatar scene comprising a selectable avatar item;
upon the user selecting the selectable avatar item, displaying, on the display device, an avatar expression linguistically associated with the selectable avatar item; and
upon the user selecting the avatar expression, displaying, on the display device, a graphical representation of a sentence including linguistic representations of the avatar expression and the selectable avatar item.

14. The method of claim 8, wherein the sentence is output in a language other than the language in which the graphical representation is displayed.

15. The method of claim 8, further comprising:
upon the user selecting the selectable item, provide a game reward to the user.

16. The method of claim 8, wherein the selectable item is hidden at times when the user is not likely to select the item.

17. A computer readable medium, comprising instructions that, when executed by a processor, cause a device to:
display a primary scene comprising a selectable model;
upon a user selecting the selectable model of the primary scene, display a secondary scene representative of the selectable model, the secondary scene comprising a selectable sub-model;
upon the user selecting the selectable sub-model, display a tertiary scene comprising a selectable item;
upon the user selecting the selectable item, display an expression linguistically associated with the selectable item;
upon the user selecting the expression, display a graphical representation of a sentence including linguistic representations of the expression and the selectable item;
upon the user indicating sentence completion, output the sentence.

18. The computer readable medium of claim 17, further comprising instructions that, when executed by the processor, cause the device to:
display a selectable component representing a user avatar;
upon the user selecting the selectable component, display a user avatar scene comprising a selectable avatar item;
upon the user selecting the selectable avatar item, display an avatar expression linguistically associated with the selectable avatar item; and
upon the user selecting the avatar expression, display a graphical representation of a sentence including linguistic representations of the avatar expression and the selectable avatar item.

19. The computer readable medium of claim 18, wherein the user avatar is customizable by the user.

20. The computer readable medium of claim 17, wherein the selectable model represents the user's bedroom, the selectable sub-model represents the user's closet, and the selectable item represents a real-world article of clothing.
